(19) United States
(12) Patent Application Publication
(10) Pub. No.: US 2016/0366874 A1
(43) Pub. Date: Dec. 22, 2016

(54) REMOTELY CONTROLLED ACTIVE DISPENSING DEVICE

(71) Applicant: RECKITT BENCKISER (BRANDS) LIMITED, Slough (GB)

(72) Inventor: Matias Caride, Slough (GB)

(21) Appl. No.: 15/254,001

(22) Filed: Sep. 1, 2016

Related U.S. Application Data
(63) Continuation of application No. PCT/GB2015/050625, filed on Mar. 4, 2015.

(30) Foreign Application Priority Data
Mar. 4, 2014 (GB) 1403806.1

(51) Int. Cl. A01M 1/20; A01M 1/24

(52) U.S. Cl. CPC A01M 1/2044; A01M 1/2038; A01M 1/245

(57) ABSTRACT

A device for dispensing an active ingredient that can be controlled remotely, most preferably wirelessly.

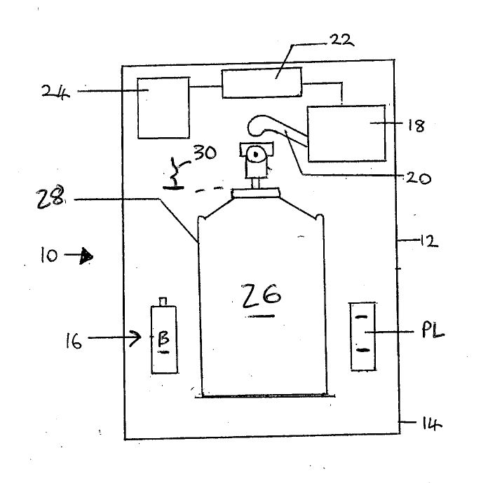

### CROSS-REFERENCE TO RELATED APPLICATIONS

This application is a continuation of International Patent Application No. PCT/GB2015/050625 filed 4 Mar. 2015, which claims the benefit of GB Patent Application No. 1403806.1 filed 4 Mar. 2014, the entire contents and substance of which are hereby incorporated by reference.

### BACKGROUND OF THE INVENTION

1. Field of the Invention

The present invention relates to a device for dispensing an active ingredient that can be controlled remotely, most preferably wirelessly.

2. Description of Related Art

Devices that release actives are well known in the fragrance and pesticide field.

These include aerosol devices and liquid electrical devices which are well known for their use in the home and public buildings.

These devices can only be controlled locally and manually to adjust, for instance, their rate of active release or to shut them down completely when not required.

However problems can arise when these devices are not accessible locally. Valuable actives may be wasted when they are not needed or vice versa.

It is the object of the present invention to attempt to address this issue.

### BRIEF SUMMARY OF THE INVENTION

It is the object of the present invention to provide a device for dispensing at least one active ingredient comprising at least one electromechanical actuator configured to release the at least one active ingredient from a reservoir, at least one replaceable reservoir containing the active ingredient, a source of electrical energy, a transmitter for sending and receiving wireless signals, and microprocessor for controlling the actuator and transmitter, optionally including software, wherein the device can be controlled remotely.

In a further aspect of the present invention the active ingredient comprises a pesticide or a fragrance.

In a further aspect of the present invention the active ingredient comprises an insecticide.

In a further aspect of the present invention the active ingredient comprises a pyrethroid.

In a further aspect of the present invention the source of electrical energy comprises a battery or plug to enable the device to be connected to mains electricity.

In a further aspect of the present invention the reservoir comprises a liquid solvent and active and the device further comprises a wick.

In a further aspect of the present invention the reservoir comprises an aerosol canister further comprising a propellant and the active.

In a further aspect of the present invention the device is connected to the internet.

In a further aspect of the present invention the transmitter is able to send and receive signals using Bluetooth, Wi-Fi or ZigBee.

In a further aspect of the present invention the transmitter is able to send and receive wireless local area network (WLAN) computer communication in the 2.4, 3.6, 5 and 60 GHz frequency bands.

In a further aspect of the present invention the transmitter is able to send and receive data via mobile phone networks.

In a further aspect of the present invention the device may be controlled by a mobile phone device.

In a further aspect of the present invention the device may be controlled over the internet.

These and other objects, features and advantages of the present invention will become more apparent upon reading the following specification in conjunction with the accompanying drawing figures.

### BRIEF DESCRIPTION OF THE DRAWING

The sole FIGURE is a schematic of the present invention according to an exemplary embodiment.

### DETAIL DESCRIPTION OF THE INVENTION

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

In an exemplary embodiment, the present invention 10 comprises a device 14 for dispensing at least one active ingredient comprising at least one electromechanical actuator 18/20 configured to release at least one active ingredient from a reservoir 26, at least one replaceable reservoir 26 containing at least one active ingredient, a source 16 of electrical energy, a transmitter 24 for sending and receiving wireless signals, and a microprocessor 22 for controlling the actuator 18/20 and transmitter 24, wherein the device can be controlled remotely.

The source 16 of electrical energy can comprise a battery B or a plug PL to enable the device to be connected to mains electricity.

The device 14 can further comprise a wick 30.

The reservoir 26 can hold a liquid solvent and the active ingredient.

The reservoir 26 can comprise an aerosol canister 28 containing a propellant and the active ingredient.

Liquid electrical devices and aerosol dispensers are well known in the art. WO2005/084721, WO2008/056131 and WO2013/124651 are all disclosures of examples of such devices. The contents of each of these three references are herein incorporated by reference.

The present invention provides for modifications to this art to allow these devices to be controlled remotely.

The devices may release any type of actives. The preferred actives are fragrances and pesticide compositions.

The preferred pesticides are insecticides. The preferred insecticides are pyrethroid actives. Non limiting examples of suitable actives are; Allethrin (the first pyrethroid synthesized), Bifenthrin, Cyfluthrin (dichlorovinyl derivative of pyrethrin), Cypermethrin (including the resolved isomer alpha-cypermethrin, dichlorovinyl derivative of pyrethrin), Cyphenothrin, Deltamethrin (dibromovinyl derivative of pyrethrin), Esfenvalerate, Etofenprox, Fenpropathrin, Fenvalerate, Flucythrinate, Flumethrin, Imiprothrin, lambda-Cyhalothrin, Metofluthrin, Permethrin, dichlorovinyl derivative of pyrethrin, Prallethrin, Resmethrin, Silafluofen, Sumithrin, tau-Fluvalinate, Tefluthrin, Tetramethrin, Tralomethrin, Transfluthrin.

The actives may be present in at least one reservoir in the device. The at least one reservoir may be replaceable when empty. The device may contain two or more reservoirs. The two or more reservoirs may contain the same active or they may contain different actives.

The at least one reservoir may be a simple container. Preferably the active is contained within a liquid within the container. The liquid may compromise a solvent. The solvent may be organic or water based. The skilled person will be aware of suitable liquid formulations in the art.

The at least one reservoir may be a pressurized aerosol cylinder. The aerosol may comprise aerosol propellant. The skilled person will be aware of suitable aerosol formulations in the art.

Where more than one reservoir is present, they may be of the same type. Or they may be different (one liquid and one aerosol, for example).

The device will comprise an electromechanical actuator. This will transform signals from the microprocessor into physical actions. These may comprise, increasing the rate of active release or decreasing the rate of release. The actuator may switch the entire device on or off.

The actuator may provide additional operations.

In a liquid electrical embodiment the actuator may increase the rate of active dispensation by adjusting the temperature of a wick component. In an aerosol embodiment the actuator may increase the rate of active release by activating the valve for longer time periods.

The device will comprise some form of microprocessor to control signals to and from the transmitter and actuator. This may be programmable remotely or may have fixed firmware.

The device will comprise an electrical power supply to enable it to function. This may be contained within the device or this may comprise an external plug that can be connected to an external electrical power source.

A preferred internal source of power is one or more batteries.

The device will comprise a transmitter to enable it to send and receive wireless signals. These signals may comprise any known in the art.

An example of the signals intended are those defined by the term Bluetooth™. These are fairly short range signals that allow direct line of sight communication.

A more preferred transmitted would be one that is able to send and receive wireless local area network (WLAN) computer communication in the 2.4, 3.6, 5 and 60 GHz frequency bands. This is preferred as it would allow connectivity to existing home or office Wi-Fi networks. The device may then connect to standard wireless routers.

Another highly preferred signal type for the transmitter to use is the Zigbee standard. This is specially designed for devices that require low data rates and long battery life.

Example signal protocols are those approved by the IEEE 802 standards committee.

This would allow easy access for the device to the internet. It is preferred that the device will have access to the internet.

The device may be controlled over the local wireless network. Preferably the device may be controlled over the internet.

Additionally or alternatively the transmitter may be able to send and receive data over mobile phone communications networks using so called 3G or 4G signals.

The device may be controlled by any computer or computer type device that is connected to the internet. This may require specialist software.

In a preferred example the device may be controlled from a smart mobile phone using a specialized application. The application may be downloaded from an online application store.

When the device comprises one or more pesticide actives, the device may be efficiently disabled if the location of the device is not needed, for example overnight of the device is located in an office.

This conserves valuable active and extends the life of each refill reservoir. The device can be activated again just prior to arrival in the office, such that an insect free environment can be generated again prior to actual entry into the office space.

This prevents any insect bites on arrival at the office that would occur while waiting for the devices of the art to warm up when they are switched on in the morning.

The devices may also be configured to monitor the level of active remaining in the at least one reservoir and either warn the owner via message through the software, or alternatively order new refill reservoirs directly.

In some instances, a computing device may be referred to as a mobile device, mobile computing device, a mobile station (MS), terminal, cellular phone, cellular handset, personal digital assistant (PDA), smart phone, wireless phone, organizer, handheld computer, desktop computer, laptop computer, tablet computer, set-top box, television, appliance, game device, medical device, display device, or some other like terminology. In other instances, a computing device may be a processor, controller, or a central processing unit (CPU). In yet other instances, a computing device may be a set of hardware components.

Various aspects described herein may be implemented using standard programming or engineering techniques to produce software, firmware, hardware, or any combination thereof to control a computing device to implement the disclosed subject matter. A computer-readable medium may include, for example: a magnetic storage device such as a hard disk, a floppy disk or a magnetic strip; an optical storage device such as a compact disk (CD) or digital versatile disk (DVD); a smart card; and a flash memory device such as a card, stick or key drive, or embedded component. Additionally, it should be appreciated that a carrier wave may be employed to carry computer-readable electronic data including those used in transmitting and receiving electronic data such as electronic mail (e-mail) or in accessing a computer network such as the Internet or a local area network (LAN). Of course, a person of ordinary skill in the art will recognize many modifications may be made to this configuration without departing from the scope or spirit of the claimed subject matter.

Various systems, methods, and computer-readable mediums may be utilized for gamifying real-time network communications between users and will now be described with reference to the accompanying figures.

It will be understood by those of skill in the art that the present invention may incorporate various types computing device architectures. They may be embodied in a computing device (for example, a dedicated server computer or a mobile computing device). It will be understood that the computing device architecture is provided for example purposes only and does not limit the scope of the various embodiments of the present disclosed systems, methods, and computer-readable mediums.

The computing device architecture can include a CPU, where computer instructions are processed; a display interface that acts as a communication interface and provides functions for rendering video, graphics, images, and texts on the display. According to certain some embodiments of the disclosed technology, the display interface may be directly connected to a local display, such as a touch-screen display associated with a mobile computing device. In another example embodiment, the display interface may be configured for providing data, images, and other information for an external/remote display that is not necessarily physically connected to the mobile computing device. For example, a desktop monitor may be utilized for mirroring graphics and other information that is presented on a mobile computing device. According to certain some embodiments, the display interface may wirelessly communicate, for example, via a Wi-Fi channel or other available network connection interface to the external/remote display.

In an example embodiment, the network connection interface may be configured as a communication interface and may provide functions for rendering video, graphics, images, text, other information, or any combination thereof on the display. In one example, a communication interface may include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof.

The computing device architecture may include a keyboard interface that provides a communication interface to a keyboard. The computing device architecture may be configured to use an input device via one or more of input/output interfaces (for example, the keyboard interface, the display interface, the presence sensitive display interface, network connection interface, camera interface, sound interface, etc.) to allow a user to capture information into the computing device architecture. The input device may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor, a smartcard, and the like. Additionally, the input device may be integrated with the computing device architecture or may be a separate device. For example, the input device may be an accelerometer, a magnetometer, a digital camera, a microphone, and an optical sensor.

Example embodiments of the computing device architecture may include an antenna interface that provides a communication interface to an antenna; a network connection interface that provides a communication interface to a network. According to certain embodiments, a camera interface is provided that acts as a communication interface and provides functions for capturing digital images from a camera or other image/video capture device. According to certain embodiments, a sound interface is provided as a communication interface for converting sound into electrical signals using a microphone and for converting electrical signals into sound using a speaker. According to example embodiments, a random access memory (RAM) is provided, where computer instructions and data may be stored in a volatile memory device for processing by the CPU.

According to an example embodiment, the computing device architecture includes a read-only memory (ROM) where invariant low-level system code or data for basic system functions such as basic input and output (I/O), startup, or reception of keystrokes from a keyboard are stored in a non-volatile memory device. According to an example embodiment, the computing device architecture includes a storage medium or other suitable type of memory (e.g., RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system, application programs (including, for example, a web browser application, a widget or gadget engine, and or other applications, as necessary) and data files are stored. According to an example embodiment, the computing device architecture includes a power source that provides an appropriate alternating current (AC) or direct current (DC) to power components. According to an example embodiment, the computing device architecture includes a telephony subsystem that allows the device to transmit and receive sound over a telephone network. The constituent devices and the CPU communicate with each other over a bus.

According to an example embodiment, the CPU has appropriate structure to be a computer processor. In one arrangement, the CPU may include more than one processing unit. The RAM interfaces with the computer bus to provide quick RAM storage to the CPU during the execution of software programs such as the operating system application programs, and device drivers. More specifically, the CPU loads computer-executable process steps from the storage medium or other media into a field of the RAM in order to execute software programs. Data may be stored in the RAM, where the data may be accessed by the computer CPU during execution. In one example configuration, the device architecture includes at least 125 MB of RAM, and 256 MB of flash memory.

The storage medium itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow a computing device to access computer-executable process steps, application programs and the like, stored on removable and non-removable memory media, to off-load data from the device or to upload data onto the device. A computer program product, such as one utilizing a communication system may be tangibly embodied in storage medium, which may comprise a machine-readable storage medium.

According to one example embodiment, the term computing device, as used herein, may be a CPU, or conceptualized as a CPU (for example, the CPU). In this example embodiment, the computing device may be coupled, connected, or in communication with one or more peripheral devices, such as display, camera, speaker, or microphone.

In some embodiments of the disclosed technology, the computing device may include any number of hardware or software applications that are executed to facilitate any of the operations. In some embodiments, one or more I/O interfaces may facilitate communication between the computing device and one or more input/output devices. For example, a universal serial bus port, a serial port, a disk drive, a CD-ROM drive, or one or more user interface devices, such as a display, keyboard, keypad, mouse, control panel, touch screen display, microphone, etc., may facilitate user interaction with the computing device. The one or more I/O interfaces may be utilized to receive or collect data and/or user instructions from a wide variety of input devices. Received data may be processed by one or more computer processors as desired in various embodiments of the disclosed technology and/or stored in one or more memory devices.

One or more network interfaces may facilitate connection of the computing device inputs and outputs to one or more suitable networks or connections; for example, the connections that facilitate communication with any number of sensors associated with the system. The one or more network interfaces may further facilitate connection to one or more suitable networks; for example, a local area network, a wide area network, the Internet, a cellular network, a radio-frequency network, a Bluetooth-enabled network, a Wi-Fi-enabled network, a satellite-based network, any wired network, any wireless network, etc., for communication with external devices or systems.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

What is claimed is:

1. A device for dispensing at least one active ingredient comprising:
at least one electromechanical actuator configured to release at least one active ingredient from a reservoir;
at least one replaceable reservoir containing at least one active ingredient;
a source of electrical energy;
a transmitter for sending and receiving wireless signals; and
a microprocessor for controlling the actuator and transmitter;
wherein the device can be controlled remotely.

2. The device according to claim 1, wherein the source of electrical energy comprises one of a battery and a plug to enable the device to be connected to mains electricity.

3. The device according to claim 1 further comprising a wick.
wherein at least one reservoir comprises a liquid solvent and the active ingredient.

4. The device according to claim 1, wherein at least one reservoir comprises an aerosol canister containing a propellant and the active ingredient.

5. The device according to claim 1, wherein the device is connected to the internet.

6. The device according to claim 1, wherein the transmitter is able to send and receive signals using Bluetooth.

7. The device according to claim 1, wherein the transmitter is able to send and receive wireless local area network (WLAN) computer communication in one or more of the 2.4, 3.6, 5 and 60 GHz frequency bands.

8. The device according to claim 1, wherein the transmitter is able to send and receive data via mobile phone networks.

9. The device according to claim 1, wherein the device is configured to be controlled by a mobile phone device.

10. The device according to claim 1, wherein the device is configured to be controlled over the internet.

11. The device according to claim 1, wherein the microprocessor includes software.

12. The device according to claim 1, wherein at least one active ingredient is selected from the group consisting of a pesticide, an insecticide, and a fragrance.

13. The device according to claim 12, wherein at least one active ingredient is a pesticide comprising a pyrethroid compound.

14. A method of remotely protecting an internal space from insects comprising:
providing the device of claim 10; and
controlling the device with one or more internet based systems.

15. A method of remotely protecting an internal space from insects comprising:
providing the device of claim 10; and
activating the device remotely internet based insect alert system when the risk level of insects exceeds a predetermined level.

16. The method of claim 14, wherein controlling the device with one or more internet based systems comprises controlling the device with one or more computer programs and mobile phone applications.

17. The method of claim 15, wherein the alert system uses local weather conditions to determine the risk level of insects.
